(19) United States
(12) Patent Application Publication
(10) Pub. No.: US 2005/0154561 A1
(43) Pub. Date: Jul. 14, 2005

(54) Method for performing failure mode and effects analysis

(76) Inventors: Susan Legault, Oxford, MI (US); Charlene Gasparovich, Shelby Township, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/755,798

(22) Filed: Jan. 12, 2004

(51) Int. Cl. G06F 11/30

(52) U.S. Cl. 702/183

(57) ABSTRACT

A method for performing failure mode and effects analysis of an intended process includes gathering data related to failures and deficiencies occurring in a similar process. Then, potential failures and deficiences are identified in the intended process by a first entity based on the gathered data. Finally, a failure mode and effects analysis is performed on the intended process by a second entity based on the potential failures identified by the first entity.

### FIELD OF THE INVENTION

The present invention relates to a method for analyzing failures and more particularly to a method of performing a failure mode and effects analysis.

### BACKGROUND OF THE INVENTION

Complicated processes, whether related to manufacturing or designing a product, are inherently subject to a variety of possible failures. This is especially true for brand new processes being implemented for the first time. Accordingly, it has become a top priority within industry to eliminate as much as possible these unwelcome errors.

One typical tool that has been used to combat these errors is the failure mode and effects analysis. The failure mode and effects analysis essentially consists of gathering a group of individuals related to the process that is under review and brainstorming all the potential failures, their possible effects, and any workable solutions. This method has not always worked well in the past and can be somewhat ponderous with complicated processes. Specifically, it is often unorganized, unprepared, and inefficient. In this regard, there remains a need in the art for an improved method of performing a failure mode and effects analysis.

### SUMMARY OF THE INVENTION

A method for performing failure mode and effects analysis of an intended process includes gathering data related to failures occurring in a similar process. Then, potential failures are identified in the intended process by a first entity based on the gathered data. Finally, a failure mode and effects analysis is performed on the intended process by a second entity based on the potential failures identified by the first entity.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a method for performing a failure and effects mode analysis according to the principles of the present invention;

FIG. 2 is an expanded block diagram of a portion of the method for performing a failure and effects mode analysis of the present invention;

FIGS. 3A and 3B are exemplary severity ranking charts used with the method of the present invention;

FIG. 4 is an exemplary data sheet used in the method of the present invention;

FIG. 5 is an exemplary occurrence ranking chart used with the method of the present invention;

FIGS. 6A, 6B, and 6C are exemplary detection ranking charts used with the method of the present invention; and

FIG. 7 is a block diagram of an exemplary embodiment of the method for performing a failure and effects mode analysis of the present invention

### DETAILED DESCRIPTION OF THE PREFERRED EMBODIMENTS

The following description of the preferred embodiment(s) is merely exemplary in nature and is in no way intended to limit the invention, its application, or uses.

With reference to FIG. 1, there is illustrated a method for performing a failure and effects mode analysis (the method) generally indicated by reference numeral 10 arranged according to the principles of the present invention. Generally speaking, failure mode and effects analysis is a tool used in many industries to examine a process, be it manufacturing, design, or administrative, and determine what the likely failures are and the possible effects of such failures. The method 10 includes the steps of data gathering 12 followed by identifying potential failures at step 14 and then performing an analysis at step 16.

A first entity (illustrated schematically by box 18) performs the steps of gathering data 12 and identifying potential failures 14. In a preferred application of the method 10, the first entity is comprised of a small number of individuals that are capable of organizing and implementing the method 10. A second entity (illustrated schematically by box 20) performs the step of analysis 16. Preferably, the second entity 20 is comprised of, in part, the first entity 18, along with any number of other individuals who will be able to contribute to the failure and effects mode analysis 16. In this regard, the second entity 20 is larger than the first entity 18.

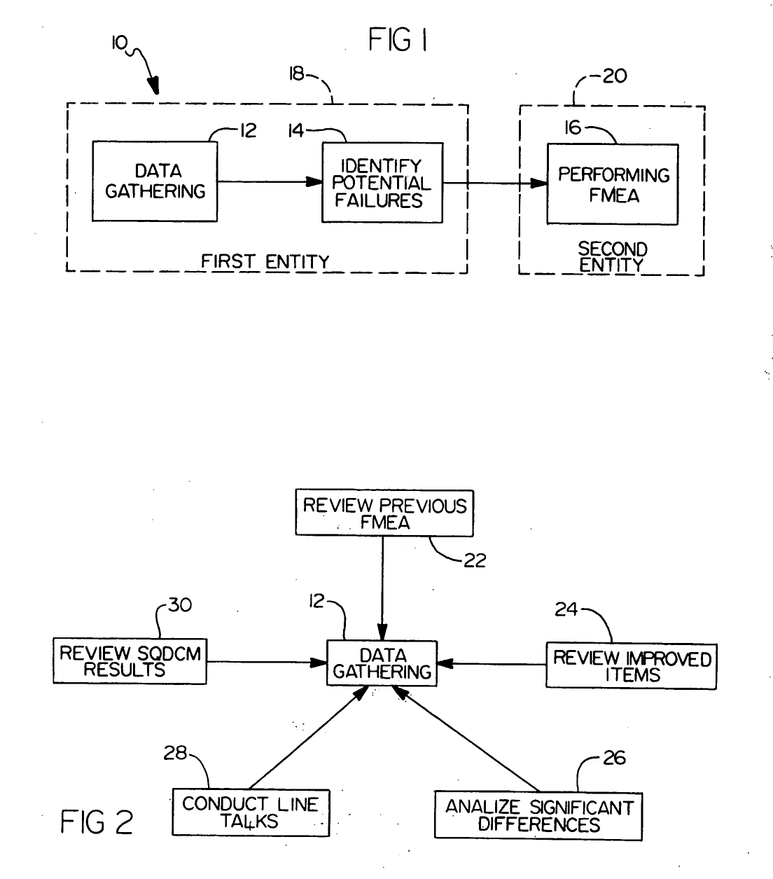

Turning to FIG. 2, the step of data gathering 12 includes a number of inputs that must be performed by the first entity 18. These include, but are not limited to, reviewing previous failure mode and effects analyses 22, reviewing improved items 24, analyzing significant differences 26, conducting line talks 28, and reviewing safety/quality information 30. Each of these steps will be discussed in turn.

Reviewing previous failure mode and effects analyses 22 generally includes compiling previously completed failure mode and effects analyses from either the same process being analyzed or from similar processes. In addition, other types of design machines should be analyzed. Then, individual risk areas can be separated out and used as part of the information needed in performing the failure mode and effects analysis 16 on the process.

The step of reviewing improved items 24 includes compiling and reviewing all the actual recorded failures that have occurred in related processes and the solutions that were implemented in response thereto. This provides the first entity 18 a ready supply of potential solutions to any issues that arise during the failure mode and effects analysis 16.

The step of analyzing significant differences 26 includes reviewing the differences between any products that derive from processes similar to the process under review and the product that derives from the process under review. If the process under review is not new but rather a variation on an old process, the differences between the old process and the process under review should be analyzed. For example, in the case of a manufacturing processes, products may be reviewed for differences in tolerances and materials.

The step of conducting line talks 28 includes at least a portion of the first entity 16 arriving on site to the location where the process under review is performed and analyzing site conditions. This also includes interviewing individuals who are associated with the process under review. If the process under review is brand new, a similar process may be analyzed.

The step of reviewing safety/quality data 30 includes compiling all information available on the process under review relating to actual safety and quality issues. For example, safety offices can be interviewed for data on the process or product, environmental concerns with the process gathered, warranty information compiled, scrap information, etc. Essentially, any and all known defects or failures are assembled. If the process under review is brand new, the safety/quality data from a similar process may be used.

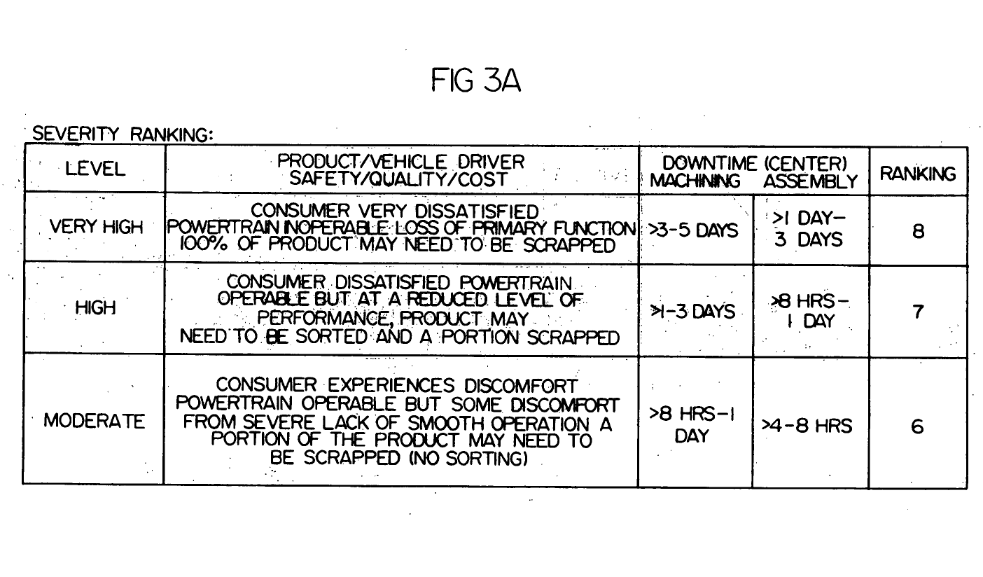

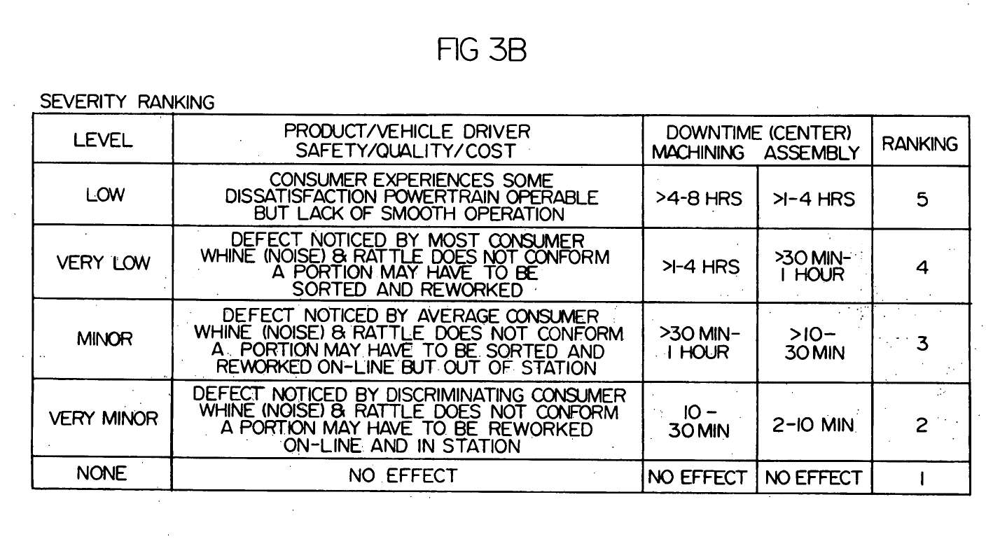

Returning to FIG. 1, after completion of the data gathering 12, the first entity 18 identifies the potential failures 14. In this step, the first entity 18 analyzes the gathered data in step 12 and identifies all possible defects that might arise during the process that is under review. These potential failures are listed and then assigned a severity rating. The severity ranking is a standardized ranking system defined by the potential damage from the failure, the cost of the failure in terms of money, and the cost of the failure in terms of time. An exemplary severity chart is provided in FIG. 3.

Once accomplished, at some later point the second entity 20 performs the failure mode and effects analysis at step 16 on the process under review. At this point, the second entity 20 conducts a group meeting and, for every operation performed in the process under review and every corresponding potential failure determined at step 14, a number of factors or attributes are determined.

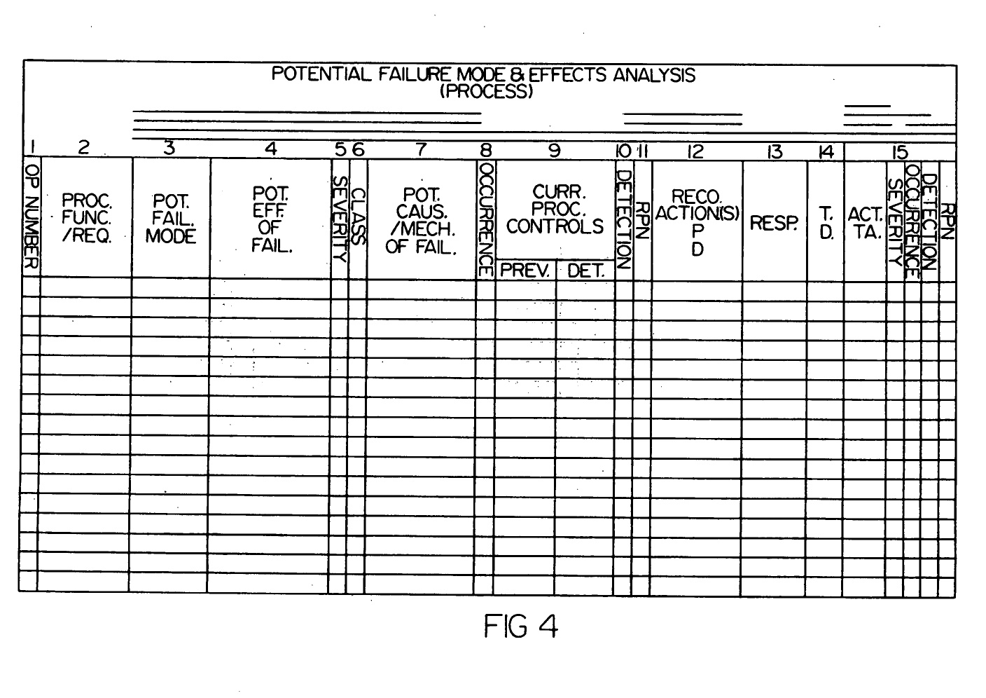

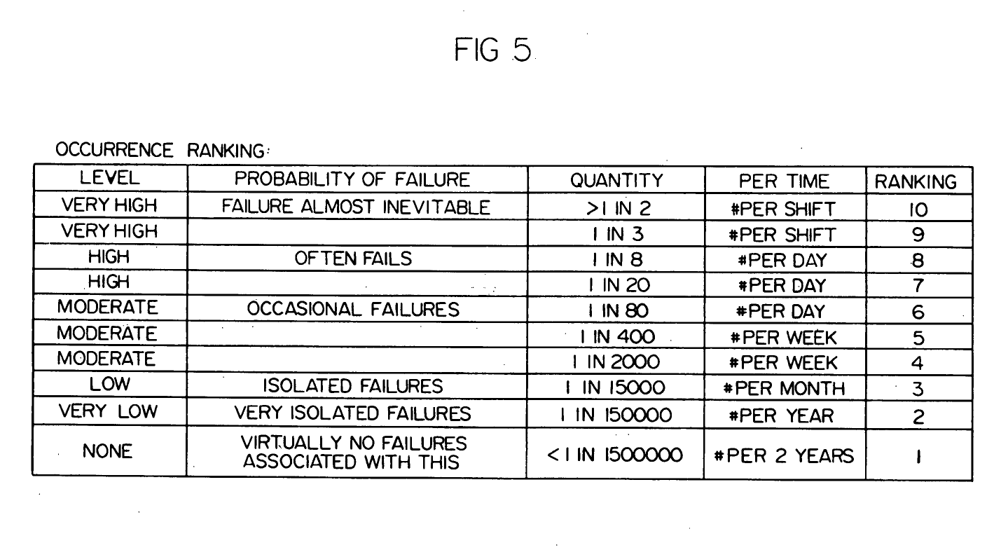

Turning to FIG. 4, an exemplary data sheet is provided used at step 16 taken from the Automotive Industry Action Group. Specifically, the columns correspond to the factors to be determined and the rows correspond to the specific operations and corresponding potential failures. The column headings include the operation number, the process function/requirements, the potential failure mode, the potential effects of failure, severity, class, potential causes/mechanism of failure, occurrence, current process controls (preventative and detective), detection, risk priority number, recommended action(s) (preventative and detective), responsibility, target date, and action results. Each factor corresponds to column numbers 1-15 in FIG. 4, respectively. Columns numbered 1-5 are completed prior to step 16 at step 14 by the first entity 18. Columns numbered 6-14 are completed during step 16 by the second entity 20. However, it should be appreciated that any organization of the information may be used, and that any combination of the factors may be included.

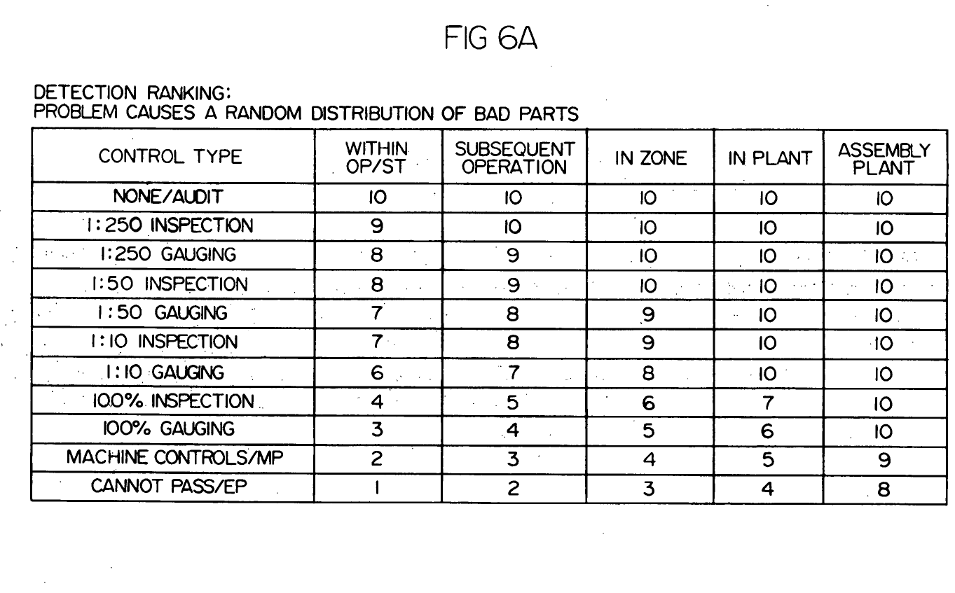

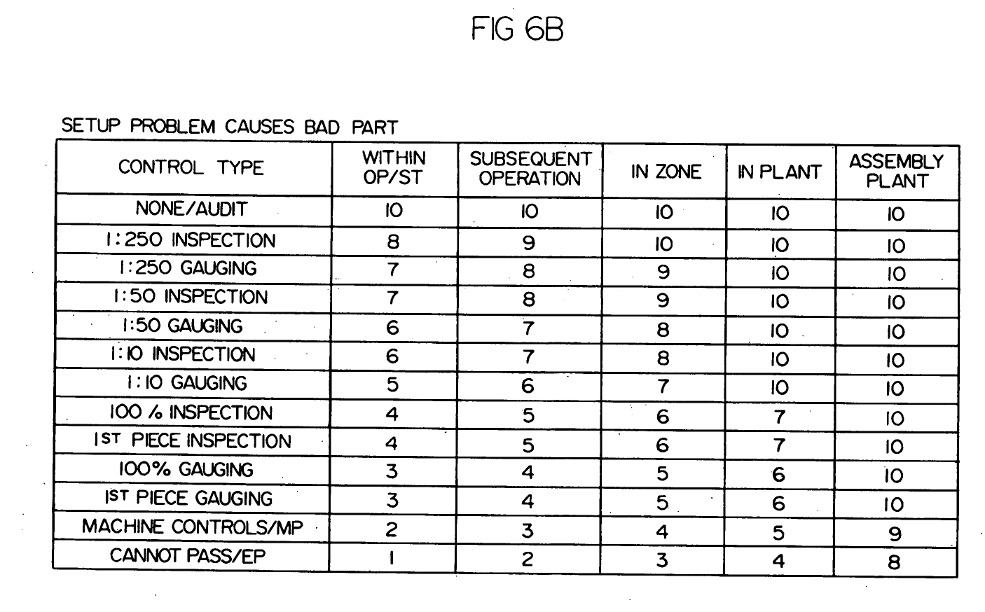

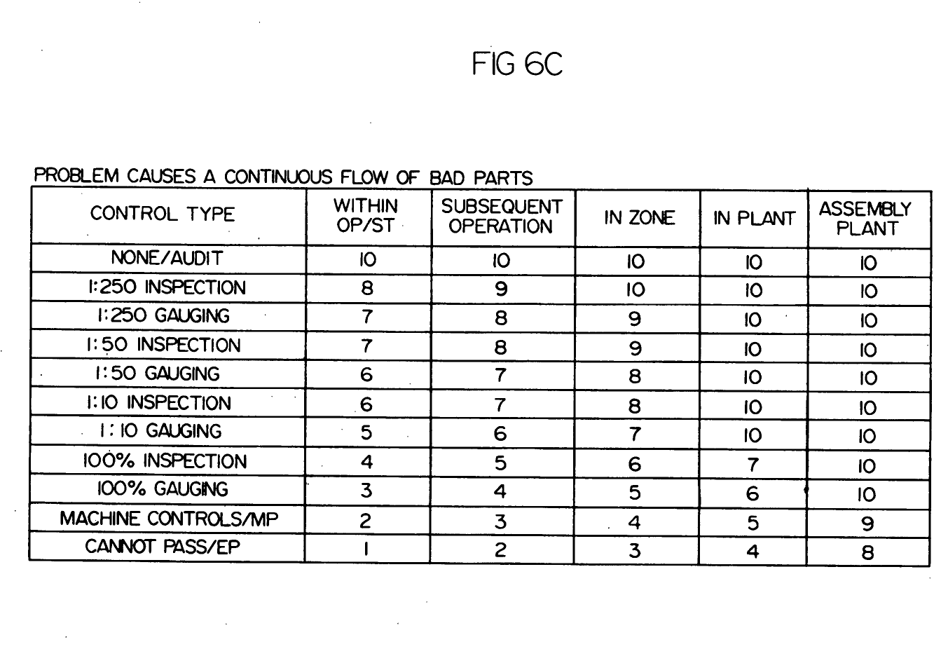

Occurrence and detection, columns 8 and 10, respectively, are ranking numbers used along with the severity rank, column 5, to objectively calculate the risk priority number, column 11. An exemplary occurrence ranking chart is provided in FIG. 5, and an exemplary detection ranking chart is provided in FIGS. 6A, 6B, and 6C. As can be seen in FIGS. 6A, 6B, and 6C, a ranking between 1 and 10 is assigned to various control types per location of the problem or failure. Moreover, the ranking is adjustable based on the frequency of the problem (e.g., in FIG. 6A the problem or failure causes a random distribution of bad parts while in FIG. 6C the problem or failure causes all the parts to be bad). It is to be understood that various other ranking charts may be employed, and each may be tailored to the specific industry or task being examined. The risk priority number in column 11 is used to rank each potential failure identified in step 14 by the first entity 18. This allows corrective or preventative action to be concentrated on the highest risk potential failures first.

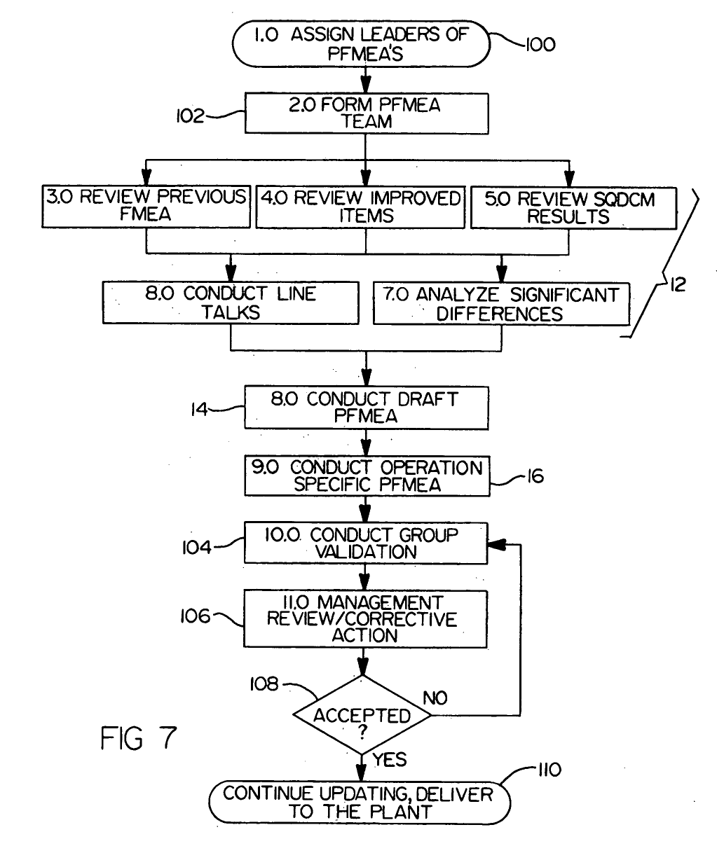

Turning now to FIG. 7, an exemplary embodiment of the method 10 is provided illustrating how the method 10 may be implemented in a working environment for reviewing a process. First, leaders are assigned to the first entity 18 by upper level management at step 100. Preferably, these leaders are individuals who have a good working knowledge of the process as a whole. Then, at step 102, the first entity 18 determines those individuals who will make up the second entity 20. These individuals will be selected from those needed to create a deep, robust failure mode and effects analysis. These individuals will then be notified of their participation in the failure mode and effects analysis and will be informed of all expectations required of them.

At step 104, the first entity 18 performs the first step 12 of the method 100 and gathers data, including the various inputs shown in FIG. 2. Gathering the data will allow the first entity 18 to more effectively and efficiently conduct the failure mode and effects analysis at step 16 with the second entity 20.

Specifically, reviewing the previous failure mode and effects analyses 22 includes focusing on finding process controls, including preventive measures (e.g., preventive maintenance, quality checks, inspection), error proofing and mistake proofing devices. These will be documented and retained for use in drafting the failure mode and effects analysis at step 14. The previous failure mode and effects analysis should also be reviewed for component parts, limited to those that substantially impact the process being analyzed. Previous tasks with high risk priority numbers and especially tasks with high detection ratings should be identified, documented and retained for use in the draft of the failure mode and effects analysis at step 14. Part design failure mode and effects analysis should also be reviewed to identify high risk priority number items, especially items with high severity ratings. These should be documented and retained for use in the draft of the failure mode and effects analysis at step 14. Finally, any historical equipment information available from the supplier, such as equipment capability studies and failure mode effects analysis, should be reviewed to identify potential equipment failures. Again, these should be documented and retained for use in the draft of the failure mode and effects analysis at step 14.

During review of improved items 24, any “What Went Right/What Went Wrong” databases should be reviewed. Solutions that might be used in the process under review should be identified and any solutions that are directly applicable as potential solutions within the process under review should be focused upon. Error proofing and mistake proofing databases should also be reviewed and solutions that are applicable to the process under review should be identified. Any “Lessons Learned” databases should also be reviewed and solutions that may be used in the process under review should be identified. The “Manufacturing Book of Knowledge” or any other guidelines source should be reviewed and any solutions that might be used in the process under review should be identified.

When analyzing significant differences 26, differences between the incoming products and any existing products should be reviewed. For example, tighter tolerances or different materials should be identified. Any differences between the process under review and existing processes should be reviewed. The impact of any identified differences on safety, quality, delivery, costs and morale (SQDCM) should be identified and assessed. Examples may include new technology, new process types, different applications for a machine or machine suppliers and new work forces. Any differences between the program supervising the process under review and any previous programs should be reviewed. Any identified differences should be assessed in relation to the impact of these differences on production launch. Examples include: deadlines restricting trials, pilots or testing, late releases and start of the program.

When conducting line talks 28, the purpose is to learn what the interviewee knows regarding the process under review or the process that is similar to the process under review. Questions that can be asked include the following: “Have you worked in this station long and do you have a good understanding of what the problems are?”; “Who would you recommend to talk to?”; “What problems have you experienced at this operation?”; “How often do they occur?”; “How easy is it to detect them?”; “Were there any issues at start up?”; “Were there any issues getting the parts out and to measure/verify that there was good quality?”; “Any issues when doing tool changes?”; “Any issues when changing or altering the product/machine or restarting the process after an emergency stop?”; “How do you know you are making a good part?”; “How do you know your machine is working well?”; “Were there any issues remembered from the start of production that had been stalled and what was the solution?” “What error proofing/mistake proofing devices have been installed and do they work well?” Various other questions may be asked and it is not intended that this list be a full and complete example, and the exemplary questions may be used in design or administrative failure mode and effects analysis.

When reviewing SQDCM results 30, any relevant parties should be accessed and all safety incidences should be identified. The Plant Environmental Office should be accessed and any site specific environmental concern should be identified. For example, the need for environmental permits should be reviewed and ways to minimize the pollutants covered under the permit should be analyzed. All information regarding warranty defects from the start of the program should be gathered as well as any improvements related to these warranty defects. Warranty defects should be linked with internal defects using discussions with resident/reliability engineers. As this information is gathered and linked, root causes (the physical reason the defect occurred), escape causes (the reason the defect escaped from the station where it was made), and system causes (what allowed the defect to occur and why it was not prevented) should be addressed. Information regarding defects should be gathered from the start of production including the links to internal defects from a tear down vehicle evaluation. Information based on vehicle audits, such as customer satisfaction audits and in-process audits should be gathered. In process audits and repair operations should be reviewed. Repair operations often link test stand defect descriptions to the physical cause of the defect and are therefore very useful. Moreover, in line testing/inspection, audits, off line gauging results, first time capability or first time through, scrap part rates, capability results, gauge reliability and repeatability data, and gauged issues, problems, and frailty should all be reviewed and gathered. Information regarding history of plant on time delivery and capacity analysis should be reviewed, as well as down time tracking including any root causes of excessive down time events. Cost drivers, such as tooling, lubricant, overtime, and root causes of high costs should also be identified and reviewed. Finally, human resources morale audits for issues regarding working conditions and non-supervisory items should be identified and reviewed.

The second step of identifying potential failures 14 of the method 10 is then performed by the first entity 18, as described above. During step 14, the first entity 18 should include tool and/or plant engineer leaders, product engineers, plant resident engineers, and any facilitators directed by management. The significant differences will be reviewed. The documented process steps and functional requirements for the entire failure mode and effects analysis will be reviewed, major issues will be identified and listed in the failure mode and effects analysis form (FIG. 4) and the customer impact of potential problems will be described as well as severity rankings established for each.

The second entity 20 convenes at step 16 to conduct the failure mode and effects analysis. The second entity 20 should include (for manufacturing processes as an example) tool engineers, plant/facilities engineers, controls engineers, supervisors, industrial engineers, product engineers, tool/process and resident engineers from the plant, plant controls engineers, plant quality engineers, plant engineering supervisors, production operators, job setters, skilled trades, supplier project leaders and engineering teams, and any facilitators directed by management. During the meeting, introductory failure mode and effects analysis training is performed. Significant processes/product differences are defined, review of the overall flow of the section under review of the process under review is performed, and a line by line review of the tasks listed in the potential failure mode and effects analysis form (FIG. 4) is completed. Potential defects are documented, occurrence and detection ratings are assigned and the risk priority number is calculated. Error proofing and mistake proofing are then brainstormed to reduce any high risk priority number items. Then responsibilities and target dates for any recommended actions are assigned.

Once step 16 is completed, a group validation is performed on the failure mode and effects analysis at step 104. The group validation focuses on reviewing the completed failure mode and effects analysis and making sure that it is fully integrated. Also, group validation links separate failure mode effects analysis's performed on separate components or processes, thereby assuring that separate corrective or preventive measures taken do not conflict with one another. Transport or handling done between the processes are examined for potential failures or deficiencies at this step.

At step 106, upper level management reviews the completed and finalized failure mode and effects analysis, as well as any corrective action that has or is being performed. If management does not accept the completed failure mode and effects analysis at step 108, the group validation at step 104 must be performed again. If, however, management is satisfied with the completed failure mode and effects analysis at step 108, then at step 110 the failure mode effects analysis is posted for all to review and use. Moreover, continuing corrective action is performed on all listed potential failures.

The description of the invention is merely exemplary in nature and, thus, variations that do not depart from the gist of the invention are intended to be within the scope of the invention. Such variations are not to be regarded as a departure from the spirit and scope of the invention.

1. A method for performing a failure mode and effects analysis of an intended process, comprising:
gathering data related to failures occurring in a similar process;
identifying potential failures in the intended process by a first entity based on the gathered data; and
performing a failure mode and effects analysis on the intended process by a second entity based on the potential failures identified by the first entity.

2. The method of claim 1, wherein the step of gathering data further comprises collecting the data at a location where the similar process is being performed.

3. The method of claim 2, wherein the step of collecting the data at the location where the similar process is being performed further comprises interviewing persons associated with the similar process.

4. The method of claim 1, wherein the step of gathering data further comprises steps selected from the group consisting of reviewing previous failure mode effects analyses performed on a similar process, reviewing improved items in a similar process, reviewing safety/quality data in a similar process, and analyzing significant differences in a similar process.

5. The method of claim 1, wherein the step of identifying potential failures further comprises quantifying a severity associated with each potential failure.

6. The method of claim 5, wherein the step of performing a failure mode and effects analysis further comprises quantifying an occurrence ranking associated with each potential failure.

7. The method of claim 6, wherein the step of performing a failure mode and effects analysis further comprises quantifying a detection ranking associated with each potential failure.

8. The method of claim 7, wherein the step of performing a failure mode and effects analysis further comprises calculating a risk priority number from the severity, the occurrence ranking, and the detection ranking, the risk priority number used to rank the order in which the potential failures will be corrected.

9. The method of claim 7, wherein the severity, occurrence ranking, and detection ranking are quantified using scoring guidelines provided by the first entity.

10. The method of claim 1, wherein the second entity is larger than the first entity.

11. The method of claim 1, wherein the second entity at least partially comprises the first entity.

12. The method of claim 1 further comprising identifying factors associated with each identified potential failure.

13. A method for performing failure mode and effects analysis of a manufacturing process, comprising:
conducting line talks with workers in the manufacturing process related to failures occurring in the manufacturing process;
identifying potential failures in the manufacturing process by a first entity based on the line talks;
ranking the severity of the potential failures by the first entity;
performing a failure mode and effects analysis on the manufacturing process by a second entity based on the potential failures identified by the first entity.

14. The method of claim 13, wherein the step of identifying potential failures further comprises quantifying a severity associated with each potential failure.

15. The method of claim 14, wherein the step of performing a failure mode and effects analysis further comprises quantifying an occurrence ranking associated with each potential failure.

16. The method of claim 15, wherein the step of performing a failure mode and effects analysis further comprises quantifying a detection ranking associated with each potential failure.

17. The method of claim 16, wherein the step of performing a failure mode and effects analysis further comprises calculating a risk priority number from the severity, the occurrence ranking, and the detection ranking, the risk priority number used to rank the order in which the potential failures will be corrected.

18. The method of claim 16, wherein the severity, occurrence ranking, and detection ranking are quantified using scoring guidelines provided by the first entity.

19. The method of claim 13, wherein the second entity is larger than the first entity.

20. The method of claim 13, wherein the second entity at least partially comprises the first entity.

21. The method of claim 13 further comprises identifying factors associated with each identified potential failure.
